(19) United States
(12) Patent Application Publication
(10) Pub. No.: US 2026/0111191 A1
(43) Pub. Date: Apr. 23, 2026

(54) Method and Device for Memory Planning for Code Generation to Create Program Code for Calculating an Artificial Neural Network in a Hardware Environment

(71) Applicant: Robert Bosch GmbH, Stuttgart (DE)

(72) Inventors: Benjamin Wagner, Friedrichshafen (DE); Duy Khoi Vo, Waiblingen (DE); Leif Sulaiman, Lund (SE); Markus Lochmann, Reutlingen (DE); Sebastian Boblest, Duernau (DE); Ulrik Hjort, Malmö (SE)

(21) Appl. No.: 19/360,533

(22) Filed: Oct. 16, 2025

(30) Foreign Application Priority Data
Oct. 18, 2024 (EP) 24207523.2

(51) Int. Cl. G06F 8/35; G06F 8/41

(52) U.S. Cl. CPC G06F 8/35; G06F 8/4434

(57) ABSTRACT

A computer-implemented method for performing memory planning for code generation to determine a code for calculating a neural network in a hardware environment includes (i) providing successive calculation steps of layers of the neural network, wherein for each calculation step the size of an input data block, an output data block and, depending on the type of calculation step, one or more model parameter blocks is determined, wherein the one or more model parameter blocks have model parameters for a respective calculation step, (ii) determining a memory planning rule for each specific calculation step that requires the use of model parameters, wherein the rule specifies that the model parameters are loaded into a contiguous memory space in a working memory of the hardware environment, and (iii) performing memory planning, in which the memory space of the respective input data block, output data block, and model parameter block is determined in the working memory for each calculation step, taking into account the determined rules.

This application claims priority under 35 U.S.C. § 119 to patent application no. EP 24207523.2, filed on Oct. 18, 2024 in the European Patent Office, the disclosure of which is incorporated herein by reference in its entirety.

The disclosure relates to the implementation of a program code on a hardware environment, such as that occurring as microcontroller-controlled control devices and the like. The disclosure further relates to methods for memory planning for handling input data, output data and model parameters.

### BACKGROUND

Certain hardware environments, such as microcontrollers in control devices, require the creation of an adjusted executable program code to take into account the characteristics and limitations of the specific hardware environment. In particular, the available memory size of the working memory that can be directly accessed by the microcontroller or acceleration hardware may be limited, or memory shift or copy operations from a data memory, such as flash or external memory, to the working memory may be particularly complex due to hardware constraints.

The calculation steps for calculating corresponding network layers of neural networks can require considerable memory, since for each calculation step an input data block, a model parameter block, and an output data block must be retrieved and stored in the working memory in a form that can be used by the microcontroller.

During memory planning, existing code generators determine in which region of the working memory the data blocks required for each calculation step are stored. During memory planning, in addition to assigning the input data blocks, output data blocks, and, if necessary, the model parameters to memory spaces of the working memory, the data generated during the calculation in a calculation step is also assigned a corresponding memory space.

Conventional code generators for neural networks do not usually assume limited working memory and typically allocate distinct memory spaces for storing the input data blocks, network parameter blocks, and output data blocks for each of the successive calculation steps. Until now, it has therefore been common practice to distribute the model parameters freely in the available memory in order to minimize the total memory requirement. However, this approach can result in the model parameters having to be copied section in sections into different memory spaces of the working memory before the calculation step is executed.

In particular, copying memory spaces from the data memory to a working memory as well as between memory spaces in the working memory is generally a time-consuming memory operation, so that memory planning must aim to reduce the total computing time caused by the execution time of memory operations.

It is the object of the present disclosure to provide improved memory management for calculating artificial neural networks in which the number of memory operations can be reduced.

### SUMMARY

This task is solved by the method for performing memory planning for code generation of a code for calculating a neural network according to the description set forth below as well as by the device also according to the description set forth below.

Further embodiments are specified in the description set forth below.

According to a first aspect, a computer-implemented method for performing memory planning for code generation to determine a code for calculating a neural network in a hardware environment, comprising the following steps:
providing successive calculation steps of layers of the neural network, wherein for each calculation step the size of an input data block, an output data block and, depending on the type of calculation step, one or more model parameter blocks is determined, wherein the one or more model parameter blocks have model parameters for a respective calculation step,
determining a memory planning rule for each specific calculation step that requires the use of model parameters, wherein the rule specifies that the model parameters are loaded into a contiguous memory space in a working memory of the hardware environment;
performing memory planning, in which the memory space of the respective input data block, output data block, and model parameter block is determined in the working memory for each calculation step, taking into account the determined rules.

In particular, performing the memory planning comprises applying an optimization method in which the target function takes into account minimizing the number of memory operations. Furthermore, performing the memory planning may comprise applying an optimization method in which the target function takes into account minimizing the total memory requirement in the working memory.

The individual calculation steps for calculating calculation layers of a neural network are typically calculated serially on a hardware environment. This means that the generated code specifies an order for the hardware environment in which the input data is processed and the output data of the respective calculation step is generated. Each calculation step takes the input data from one input data block and stores the resulting output data in one or more output data blocks Input data block and output data block represent memory spaces of the working memory which are arranged within a contiguous address space.

The hardware environment comprises a computing unit, a working memory and a data memory. A generated code for calculating a neural network is performed in the form of the calculation steps in the computing unit, wherein input data blocks and output data blocks in the working memory are used to provide the input data and store the output data. Accessing data from the working memory has short access times, while accessing the data memory requires longer access times. The aim of memory planning is to reduce access times and the total calculation duration by providing and placing the input data blocks and output data blocks in the working memory, while at the same time taking into account or limiting the maximum available memory space of the working memory.

Depending on the calculation steps that must be performed to calculate a neural network, memory operations often occur between the actual layer calculations, which involve copying to the working memory or moving memory spaces within the working memory. The memory operations are often time-consuming and also involve a significant amount of time that does not depend on the size of the memory space to be copied or moved.

The core of the above method is to plan the model parameters as a contiguous data block in a memory operation. In this way, only a single copy operation is required to make all model parameters available in the working memory. This increases the execution speed of the neural network by reducing the number of memory operations required.

In addition to the input data blocks or output data blocks of the individual calculation layers of the neural network, the memory spaces are also assigned during memory planning. The parameters used for calculating some calculation layers are also assigned memory spaces in the working memory.

Memory planning generally aims to minimize the total memory requirements in the working memory. However, this has the side effect that when a network layer calculation is performed, the model parameters of the calculation layer are copied into the working memory in sections, especially if the available memory spaces between already placed input data blocks and output data blocks are smaller than the model parameter block to be copied into the working memory.

Depending on the hardware environment, memory accesses such as copy operations, move operations, and the like can have a significant impact on the overall processing time, so it is desirable to minimize the number of copy operations required. In particular, the maximum available memory space can be taken into account when memory planning.

The memory planning can now decide whether, taking into account the size of the input data block and output data block of each of the calculation steps, the network parameters for one or more calculation steps can be copied to the working memory. The aim here is to write the network parameters from different parameter blocks to the working memory in as coherent a manner as possible, as this requires only a single copy operation. This can result in considerable time savings in the hardware environment when processing the evaluation of the neural network, especially when copying data to a working memory is a complex operation and, in particular, when it involves a high offset proportion of processing time, i.e., a proportion of processing time that is not influenced by the size of the memory space to be copied.

After memory planning, code generation is performed after memory planning, in which the model parameters are loaded in a single copy operation into the memory space assigned to the model parameter block by the memory planning.

### BRIEF DESCRIPTION OF THE DRAWINGS

Preferred embodiments are described in more detail below with reference to the accompanying drawings. The figures show:

FIG. 1 a schematic illustration of a platform for code generation and implementation in a hardware environment;

FIG. 2 a flowchart illustrating a method for performing memory planning and code generation

FIGS. 3a and 3b a comparison of a previous method and a method according to the disclosure for placing memory spaces for model parameters in a working memory of a hardware environment.

### DETAILED DESCRIPTION

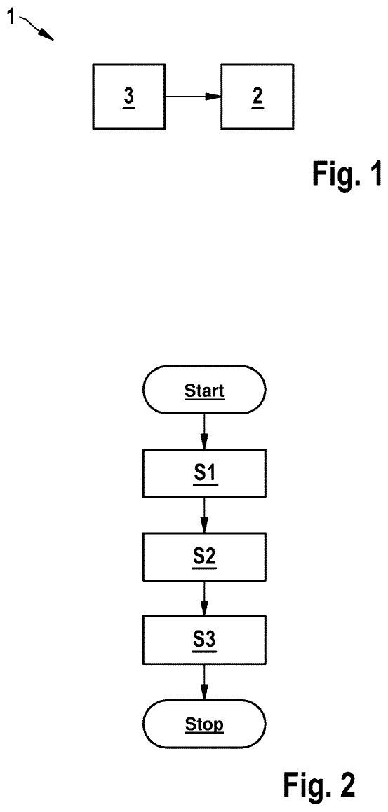

FIG. 1 shows a block diagram of a platform 1 for performing code generation and implementing a generated program code in a hardware environment 2. For example, the hardware environment corresponds to a control device having a microcontroller, microprocessor, or the like. Code generation is done on a conventional computer 3 or workstation based on the specified configuration of a neural network. Computer 3 is configured to perform memory planning and code generation, wherein memory planning first performs placement of memory spaces for the individual calculation steps of the neural network to accommodate at least one input data block, one output data block, and at least one model parameter block. The model parameter block comprises all model parameters needed for calculating the respective calculation step, e.g. weightings, bias values of a fully connected layer.

Once the code has been generated, it is transferred to the hardware environment 2, where it is implemented or executed.

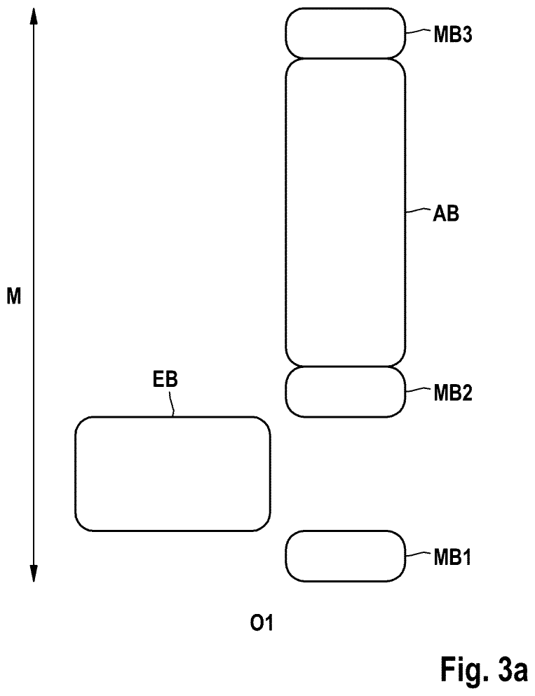

FIG. 2 shows a flowchart illustrating a method for performing memory planning and code generation for providing program code for implementing a neural network.

In step S1, the neural network with the calculation steps is specified first. The calculation steps each define the type of neural network layer to be calculated, the input data block and the resulting output data block. Model parameters can also be specified for the network layers, which are used to calculate the data elements of the output data block from the data elements of the input data block, depending on the type of network layer.

In step S2, memory planning is performed, e.g., using an SMT planner, in which the calculation steps are iterated successively and, for each calculation step, the input data block, the output data block, and the model parameter block for the model parameters are placed. The memory planning preferably corresponds to a known combinatorial optimization method.

Each of the calculation steps usually requires the input data block and, if necessary, the model parameter block to be provided in advance, as well as the reservation of memory space for the output data block. The input data block and the model parameter block are often loaded from a data memory into the working memory by way of copy operations, since the input data blocks, the output data blocks, and the model parameter block can only be processed from the working memory.

The memory planning provides for bundling the required model parameter blocks for one or more successive calculation steps and copying them into a contiguous memory space (contiguous address area) with a single copy operation, so that the time overhead for a copy operation can be minimized.

In particular, it may be provided that, in addition to the model parameters of the current calculation layer under consideration, the copy operation also copies input data blocks to be copied for the next calculation step in the same copy operation, thereby copying an input data block and one or more model parameter blocks as a contiguous memory space into the working memory in a single copy operation.

Subsequently, in step S3 during code generation, only one memory operation/copy operation is provided for copying the contiguous memory space, while model parameter blocks stored mutually spaced are copied to the working memory with separate copy operations.

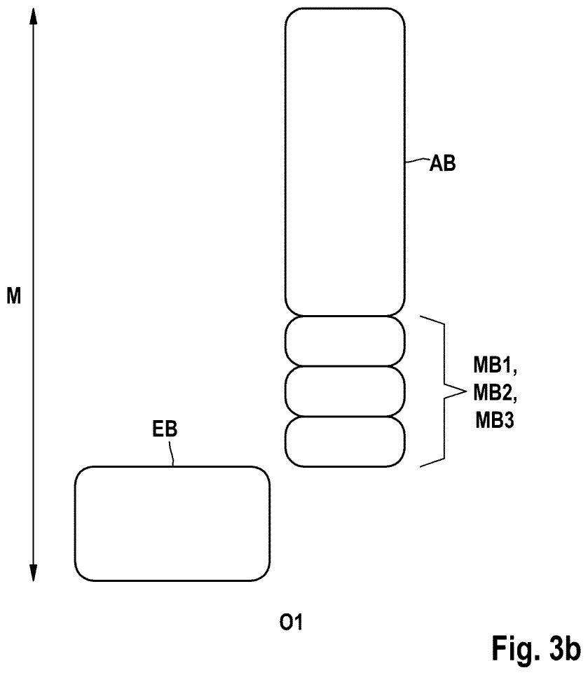

FIGS. 3a and 3b show a comparison of the results of memory planning using a conventional method and the method described above. FIG. 3a shows how model parameters in several model parameter blocks MB1, MB2, MB3 are copied to separate, mutually spaced memory spaces surrounding the output data block AB of the relevant calculation step, as is the case with conventional memory planning methods.

FIG. 3b, on the other hand, shows that the model parameter blocks MB1, MB2, MB3 are copied into the working memory in a single copy operation.

A memory copy counter can be used to optimize the processing time used for copy operations. This can count or count the required copy operations if a model parameter block MB of a certain calculation step is not connected to another model parameter block MB1, MB2, MB3 and therefore cannot be copied in a single copy operation. When determining optimal memory planning, the SMT planner can minimize the number of copy operations or take into account the minimization of the number of required memory operations in a target function.

What is claimed is:

1. A computer-implemented method for performing memory planning for code generation to determine a code for calculating a neural network in a hardware environment, comprising:
providing successive calculation steps of layers of the neural network, wherein for each calculation step the size of an input data block, an output data block and, depending on the type of calculation step, one or more model parameter blocks is determined, wherein the one or more model parameter blocks have model parameters for a respective calculation step;
determining a memory planning rule for each specific calculation step that requires the use of model parameters, wherein the rule specifies that the model parameters are loaded into a contiguous memory space in a working memory of the hardware environment; and
performing memory planning, in which the memory space of the respective input data block, output data block, and model parameter block is determined in the working memory for each calculation step, taking into account the determined rules.

2. The method according to claim 1, wherein performing the memory planning comprises applying an optimization method in which the target function takes into account minimizing the number of memory operations.

3. The method according to claim 1, wherein performing the memory planning comprises applying an optimization method in which the target function takes into account minimizing the total memory requirement in the working memory.

4. The method according to claim 1, wherein code generation is performed after memory planning, in which the model parameters are loaded in a single copy operation into the memory space assigned to the model parameter block by the memory planning.

5. A device for performing the method according to claim 1.

6. A computer program product comprising commands which, when the program is executed by at least one data processing device, cause the data processing device to perform the steps of the method according to claim 1.

7. A machine-readable storage medium comprising commands which, when executed by at least one data processing device, cause the data processing device to perform the steps of the method according to claim 1.
